(19) United States
(12) Patent Application Publication
(10) Pub. No.: US 2025/0300577 A1
(43) Pub. Date: Sep. 25, 2025

(54) COMPRESSOR WITH VARIABLE PERFORMANCE SINGLE PHASE INDUCTION MOTOR

(71) Applicant: COPELAND SCROLL COMPRESSORS LP, St. Louis, MO (US)

(72) Inventors: Vaibhav Avadhut Kadam, Punawale (IN); Vishal Vasant Salunkhe, Pune (IN); Amar Balasaheb Mohol, Pune (IN)

(73) Assignee: COPELAND SCROLL COMPRESSORS LP, St. Louis, MO (US)

(21) Appl. No.: 18/768,718

(22) Filed: Jul. 10, 2024

(30) Foreign Application Priority Data
Mar. 20, 2024 (IN) 202421021178

(51) Int. Cl. H02P 1/44

(52) U.S. Cl. CPC H02P 1/445

(57) ABSTRACT

A single phase induction motor of a scroll compressor includes: a main winding that is center tapped forming: a first winding having a first end and a second end; a second winding having a third end and a fourth end; and a node between the second end of the first winding and the third end of the second winding; a first switch: including a first input to receive single phase power from a source; including a first output connected to the first end of the first winding; and including a second output; a second switch: including a second input connected to the second output of the first switch; including a third output connected to the node between the second end of the first winding and the third end of the second winding; and an auxiliary winding.

### CROSS-REFERENCE TO RELATED APPLICATIONS

This application claims the benefit of Indian Application No. 202421021178, filed on Mar. 20, 2024. The entire disclosure of the application referenced above is incorporated herein by reference.

### FIELD

The present disclosure relates to compressors of refrigeration systems and more particularly to electric motors of compressors.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Electric motors are used in a wide variety of industrial and residential applications including, but not limited to, heating, ventilating, and air conditioning (HVAC) systems. For example only, an electric motor may drive a compressor in an HVAC system. One or more additional electric motors may also be implemented in the HVAC system. For example only, the HVAC system may include another electric motor that drives a fan associated with a condenser. Another electric motor may be included in the HVAC system to drive a fan associated with an evaporator.

### SUMMARY

In a feature, a single phase induction motor of a scroll compressor includes: a main winding that is center tapped forming: a first winding having a first end and a second end; a second winding having a third end and a fourth end; and a node between the second end of the first winding and the third end of the second winding; a first switch: including a first input to receive single phase power from a source; including a first output connected to the first end of the first winding; and including a second output; a second switch: including a second input connected to the second output of the first switch; including a third output connected to the node between the second end of the first winding and the third end of the second winding; and an auxiliary winding.

In further features, a capacitor is connected in series with the auxiliary winding.

In further features, the auxiliary winding and the capacitor are connected between the first input of the first switch and the fourth end of the second winding.

In a feature, a motor control system includes: the motor; and a switch control module configured to actuate the first and second switches.

In further features, the switch control module is configured to actuate the first and second switches based on a line current from the source.

In further features, the switch control module is configured to, when the line current is between zero and a first predetermined current: actuate the first switch and electrically connect the first input to the first output and electrically disconnect the first input from the second output.

In further features, the switch control module is further configured to, when the line current is between 0 and the first predetermined current, actuate the second switch and electrically disconnect the second input from the third output.

In further features, the switch control module is further configured to, when the line current is between the first predetermined current and a second predetermined current that is greater than the first predetermined current: actuate the first switch and electrically disconnect the first input from the first output and electrically connect the first input to the second output; and actuate the second switch and electrically connect the second input to the third output connected to the node between the second end of the first winding and the third end of the second winding.

In further features, the switch control module is further configured to, when the line current is greater than the second predetermined current: actuate the first switch and electrically disconnect the first input from both the first output and the second output; and actuate the second switch and electrically disconnect the second input from the third output connected to the node between the second end of the first winding and the third end of the second winding.

In further features, the switch control module is configured to, based on undercompression operation of the compressor: actuate the first switch and electrically connect the first input to the first output and electrically disconnect the first input from the second output.

In further features, the switch control module is further configured to, based on overcompression operation of the compressor: actuate the first switch and electrically disconnect the first input from the first output and electrically connect the first input to the second output; and actuate the second switch and electrically connect the second input to the third output connected to the node between the second end of the first winding and the third end of the second winding.

In further features, at least one of the first and second switches automatically actuates based on a line current from the source.

In a feature, a single phase induction motor of a scroll compressor includes: a main winding that is center tapped forming: a first winding having a first end and a second end; a second winding having a third end and a fourth end; and a first node between the second end of the first winding and the third end of the second winding; a first switch: including a first input to receive single phase power from a source via a second node; including a first output connected to the first end of the first winding; and including a second output connected to the first node between the second end of the first winding and the third end of the second winding; a second switch: including a second input connected to the fourth end of the second winding via a third node; including a second output connected to the source; and an auxiliary winding connected between the third node and the second node.

In further features, a capacitor is connected in series with the auxiliary winding.

In a feature, a motor control system includes: the motor; and a switch control module configured to actuate the first and second switches.

In further features, the switch control module is configured to actuate the first and second switches based on a line current from the source.

In further features, the switch control module is configured to, when the line current is between zero and a first predetermined current: actuate the first switch and electrically connect the first input to the first output and electrically disconnect the first input from the second output.

In further features, the switch control module is further configured to, when the line current is between zero and the first predetermined current, actuate the second switch and electrically disconnect the second input from the third output.

In further features, the switch control module is further configured to, when the line current is between the first predetermined current and a second predetermined current that is greater than the first predetermined current: actuate the first switch and electrically disconnect the first input from the first output and electrically connect the first input to the second output; and actuate the second switch and electrically connect the second input to the third output.

In further features, the switch control module is further configured to, when the line current is greater than the second predetermined current: actuate the first switch and electrically disconnect the first input from both the first output and the second output; and actuate the second switch and electrically disconnect the second input from the third output.

In further features, the switch control module is configured to: based on undercompression operation of the compressor, actuate the first switch and electrically connect the first input to the first output and electrically disconnect the first input from the second output; and based on overcompression operation of the compressor: actuate the first switch and electrically disconnect the first input from the first output and electrically connect the first input to the second output; and actuate the second switch and electrically connect the second input to the third output.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example refrigeration system;

FIG. 2 is a block diagram of an example implementation of the compressor motor drive of FIG. 1;

FIG. 3 is a schematic of an example implementation of the electric motor of the compressor;

FIG. 4 is a functional block diagram of an example implementation of electrical connections;

FIG. 5 is an example schematic of a model of the electric motor;

FIG. 6 is a schematic of an example implementation of the electric motor;

FIG. 7 is an example graph of the above pressures and volumes for the example of over compression;

FIG. 8 is an example graph of the above pressures and volumes for the example of over compression;

FIG. 9 includes a graph illustrating the adiabatic efficiency of a compressor for different system pressure ratio demands;

FIG. 10 is a schematic of an example implementation of the electric motor; and

FIG. 11 is a schematic of an example implementation of the electric motor.

In the drawings, reference numbers may be reused to identify similar and/or identical elements.

### DETAILED DESCRIPTION

### Refrigeration System

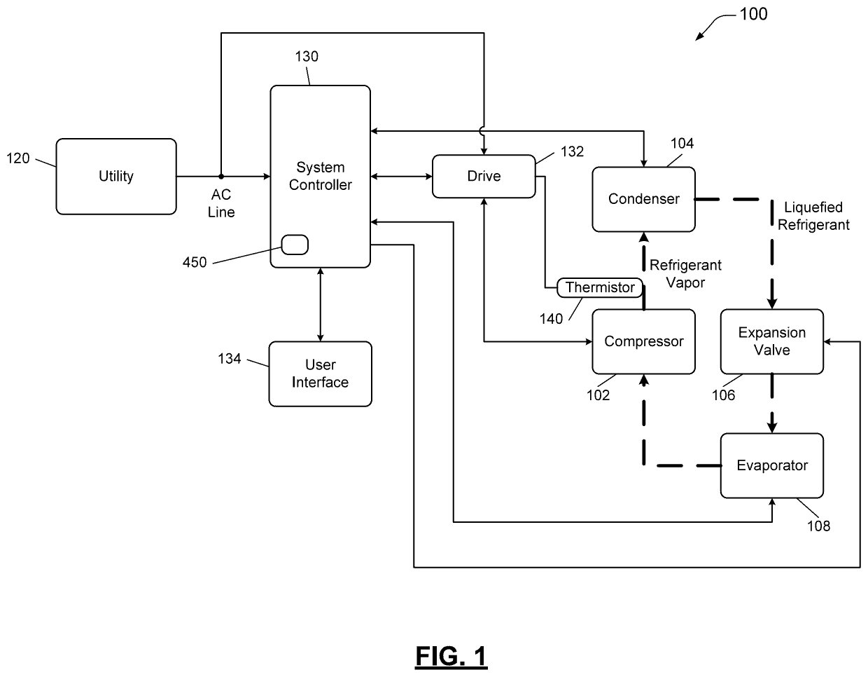

FIG. 1 is a functional block diagram of an example refrigeration system 100 including a compressor 102, a condenser 104, an expansion valve 106, and an evaporator 108. According to the principles of the present disclosure, the refrigeration system 100 may include additional and/or alternative components, such as a reversing valve or a filter-drier. In addition, the present disclosure is applicable to other types of refrigeration systems including, but not limited to, heating, ventilating, and air conditioning (HVAC), heat pump, refrigeration, and chiller systems.

The compressor 102 receives refrigerant in vapor form and compresses the refrigerant. The compressor 102 provides pressurized refrigerant in vapor form to the condenser 104. The compressor 102 includes an electric motor that drives a pump. For example only, the pump of the compressor 102 may include a scroll compressor and/or a reciprocating compressor.

All or a portion of the pressurized refrigerant is converted into liquid form within the condenser 104. The condenser 104 transfers heat away from the refrigerant, thereby cooling the refrigerant. When the refrigerant vapor is cooled to a temperature that is less than a saturation temperature, the refrigerant transforms into a liquid (or liquefied) refrigerant. The condenser 104 may include an electric fan that increases the rate of heat transfer away from the refrigerant.

The condenser 104 provides the refrigerant to the evaporator 108 via the expansion valve 106. The expansion valve 106 controls the flow rate at which the refrigerant is supplied to the evaporator 108. The expansion valve 106 may include a thermostatic expansion valve or may be controlled electronically by, for example, a system controller 130. A pressure drop caused by the expansion valve 106 may cause a portion of the liquefied refrigerant to transform back into the vapor form. In this manner, the evaporator 108 may receive a mixture of refrigerant vapor and liquefied refrigerant.

The refrigerant absorbs heat in the evaporator 108. Liquid refrigerant transitions into vapor form when warmed to a temperature that is greater than the saturation temperature of the refrigerant. The evaporator 108 may include an electric fan that increases the rate of heat transfer to the refrigerant.

A utility 120 provides power to the refrigeration system 100. For example only, the utility 120 may provide single-phase alternating current (AC) power at approximately 230 Volts root mean squared (VRMS).

The utility 120 may provide the AC power to the system controller 130 via an AC line, which includes two or more conductors. The AC power may also be provided to a drive 132 via the AC line. The system controller 130 controls the refrigeration system 100. For example only, the system controller 130 may control the refrigeration system 100 based on user inputs and/or parameters measured by various sensors (not shown). The sensors may include pressure sensors, temperature sensors, current sensors, voltage sensors, etc. The sensors may also include feedback information from the drive control, such as motor currents or torque, over a serial data bus or other suitable data buses.

A user interface 134 provides user inputs to the system controller 130. The user interface 134 may additionally or alternatively provide the user inputs directly to the drive 132. The user inputs may include, for example, a desired temperature, requests regarding operation of a fan (e.g., a request for continuous operation of the evaporator fan), and/or other suitable inputs. The user interface 134 may take the form of a thermostat, and some or all functions of the system controller (including, for example, actuating a heat source) may be incorporated into the thermostat.

The system controller 130 may control operation of the fan of the condenser 104, the fan of the evaporator 108, and the expansion valve 106. The drive 132 may control the compressor 102 based on commands from the system controller 130. For example only, the system controller 130 may instruct the drive 132 to operate the motor of the compressor 102 at a certain speed or to operate the compressor 102 at a certain capacity. In various implementations, the drive 132 may also control the condenser fan.

A thermistor 140 is thermally coupled to the refrigerant line exiting the compressor 102 that conveys refrigerant vapor to the condenser 104. The variable resistance of the thermistor 140 therefore varies with the discharge line temperature (DLT) of the compressor 102. As described in more detail, the drive 132 monitors the resistance of the thermistor 140 to determine the temperature of the refrigerant exiting the compressor 102.

The DLT may be used to control the compressor 102, such as by varying capacity of the compressor 102, and may also be used to detect a fault. For example, if the DLT exceeds the threshold, the drive 132 may power down the compressor 102 to prevent damage to the compressor 102.

### Drive

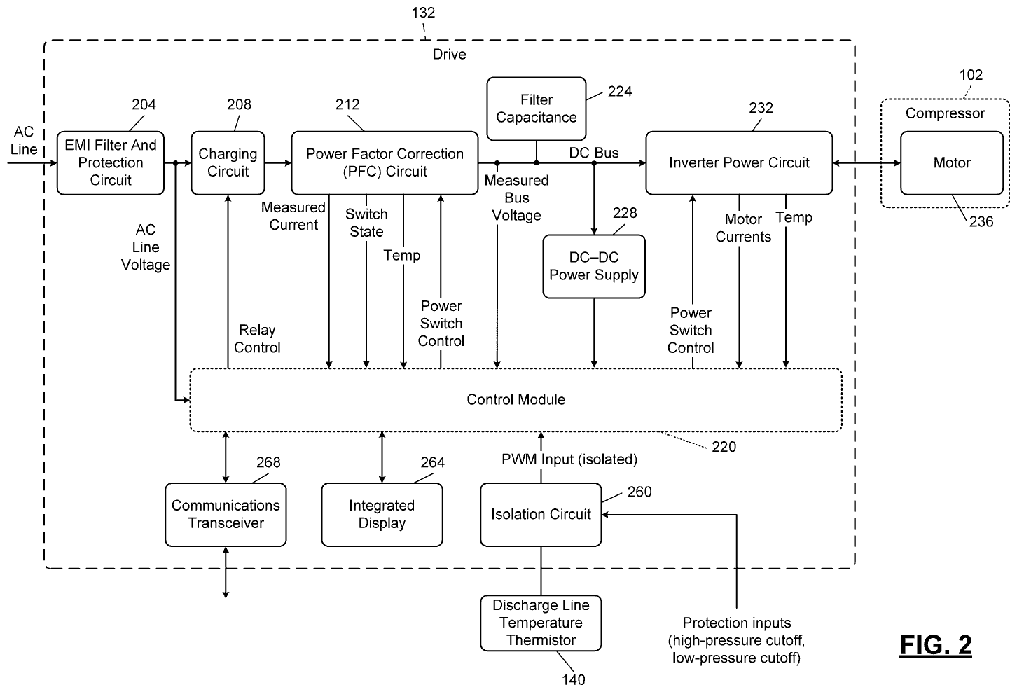

In FIG. 2, an example implementation of the drive 132 includes an electromagnetic interference (EMI) filter and protection circuit 204, which receives power from an AC line. The EMI filter and protection circuit 204 reduces EMI that might otherwise be injected back onto the AC line from the drive 132. The EMI filter and protection circuit 204 may also remove or reduce EMI arriving from the AC line. Further, the EMI filter and protection circuit 204 protects against power surges, such as may be caused by lightening, and/or other other types of power surges and sags.

A charging circuit 208 controls power supplied from the EMI filter and protection circuit 204 to a power factor correction (PFC) circuit 212. For example, when the drive 132 initially powers up, the charging circuit 208 may place a resistance in series between the EMI filter and protection circuit 204 and the PFC circuit 212 to reduce the amount of current inrush. These current or power spikes may cause various components to prematurely fail.

After initial charging is completed, the charging circuit 208 may close a relay that bypasses the current-limiting resistor. For example, a control module 220 may provide a relay control signal to the relay within the charging circuit 208. In various implementations, the control module 220 may assert the relay control signal to bypass the current-limiting resistor after a predetermined period of time following start up, or based on closed loop feedback indicating that charging is near completion.

The PFC circuit 212 converts incoming AC power to DC power. The PFC circuit 212 may not be limited to PFC functionality—for example, the PFC circuit 212 may also perform voltage conversion functions, such as acting as a boost circuit and/or a buck circuit. In some implementations, the PFC circuit 212 may be replaced by a non-PFC voltage converter. The DC power may have voltage ripples, which are reduced by filter capacitance 224. Filter capacitance 224 may include one or more capacitors arranged in parallel and connected to the DC bus. The PFC circuit 212 may attempt to draw current from the AC line in a sinusoidal pattern that matches the sinusoidal pattern of the incoming voltage. As the sinusoids align, the power factor approaches one, which represents the greatest efficiency and the least demanding load on the AC line.

The PFC circuit 212 includes one or more switches that are controlled by the control module 220 using one or more signals labeled as power switch control. The control module 220 determines the power switch control signals based on a measured voltage of the DC bus, measured current in the PFC circuit 212, AC line voltages, temperature or temperatures of the PFC circuit 212, and the measured state of a power switch in the PFC circuit 212. While the example of use of measured values is provided, the control module 220 may determine the power switch control signals based on an estimated voltage of the DC bus, estimated current in the PFC circuit 212, estimated AC line voltages, estimated temperature or temperatures of the PFC circuit 212, and/or the estimated or expected state of a power switch in the PFC circuit 212. In various implementations, the AC line voltages are measured or estimated subsequent to the EMI filter and protection circuit 204 but prior to the charging circuit 208.

The control module 220 is powered by a DC-DC power supply 228, which provides a voltage suitable for logic of the control module 220, such as 3.3 Volts, 2.5 Volts, etc. The DC-DC power supply 228 may also provide DC power for operating switches of the PFC circuit 212 and an inverter power circuit 232. For example only, this voltage may be a higher voltage than for digital logic, with 15 Volts being one example.

The inverter power circuit 232 also receives power switch control signals from the control module 220. In response to the power switch control signals, switches within the inverter power circuit 232 cause current to flow in respective windings of a motor 236 of the compressor 102. The control module 220 may receive a measurement or estimate of motor current for each winding of the motor 236 or each leg of the inverter power circuit 232. The control module 220 may also receive a temperature indication from the inverter power circuit 232.

For example only, the temperature received from the inverter power circuit 232 and the temperature received from the PFC circuit 212 are used only for fault purposes. In other words, once the temperature exceeds a predetermined threshold, a fault is declared and the drive 132 is either powered down or operated at a reduced capacity. For example, the drive 132 may be operated at a reduced capacity and if the temperature does not decrease at a predetermined rate, the drive 132 transitions to a shutdown state.

The control module 220 may also receive an indication of the discharge line temperature from the compressor 102 using the thermistor 140. An isolation circuit 260 may provide a pulse-width-modulated representation of the resistance of the thermistor 140 to the control module 220. The isolation circuit 260 may include galvanic isolation so that there is no electrical connection between the thermistor 140 and the control module 220.

The isolation circuit 260 may further receive protection inputs indicating faults, such as a high-pressure cutoff or a low-pressure cutoff, where pressure refers to refrigerant pressure. If any of the protection inputs indicate a fault and, in some implementations, if any of the protection inputs become disconnected from the isolation circuit 260, the isolation circuit 260 ceases sending the PWM temperature signal to the control module 220. Therefore, the control module 220 may infer that a protection input has been received from an absence of the PWM signal. The control module 220 may, in response, shut down the drive 132.

The control module 220 controls an integrated display 264, which may include a grid of LEDs and/or a single LED package, which may be a tri-color LED. The control module 220 can provide status information, such as firmware versions, as well as error information using the integrated display 264. The control module 220 communicates with external devices, such as the system controller 130 in FIG. 1, using a communications transceiver 268. For example only, the communications transceiver 268 may conform to the RS-485 or RS-232 serial bus standards or to the Controller Area Network (CAN) bus standard.

### Electric Motor

Built in volume ratio (BIVR) depends on the geometry of scrolls of the compressor. BIVR involves a ratio of suction volume to discharge volume.

Built in Pressure Ratio (BIPR) involves a ratio of discharge pressure to suction pressure. BIPR depends on BIVR with a factor of k (isentropic exponent (depends on refrigerant property) BIPR=BIVRk.

The pressure in the compressor will rise to a level where, P2P1=(V1V2) k. This may be true regardless of discharge pressure. In the equation above, P2 may refer to Discharge Pressure, which may be measured using a pressure sensor, P1 may refer to Suction Pressure, which may be measured using a pressure sensor. V1 may refer to a Suction Volume of the compressor, and V2 may refer to a Discharge Volume of the compressor.

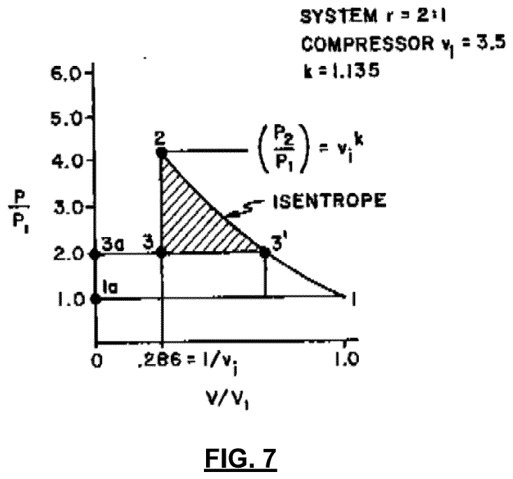

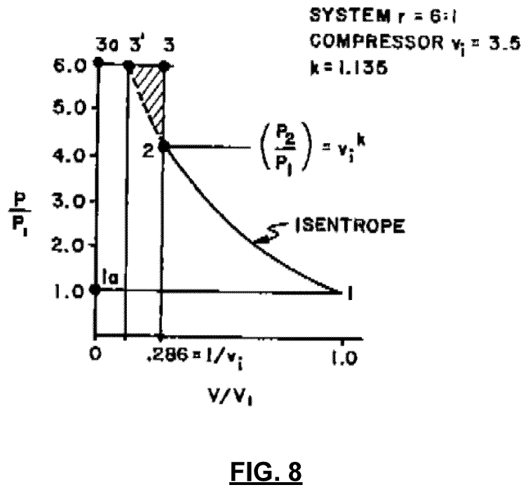

FIG. 7 is an example graph of the above pressures and volumes for the example of over compression. FIG. 8 is an example graph of the above pressures and volumes for the example of over compression.

The effect of fixed built-in volume ratio on the performance of positive displacement compressor can be understood by FIGS. 7 and 8. Assume a scroll set with built-in volume ratio of 3.5. Also, assume that isentropic constant is 1.135 for R22 Refrigerant. The built-in pressure ratios for this scroll set will be, BIVR=(3.5) 1.135=4.14

First, in the case of over compression, as an example, assume operating the compressor at 50° F./100° F. condition. The related system pressures values are 187 PSIA and 374 PSIA. Compressor system pressure ratio requirement is (374/187) which equal to 2.

If scroll geometrical design and used refrigerant are considered, BIVR and BIPR are 3.5 and 4.1 respectively. System compressor ratio requirement is 2 times but scroll will over compress the refrigerant to 4.1 times. The internal pressure rise of scroll will be above the system pressure before discharging begins. When the port opens, high pressure gas rushes out until the internal scroll and system pressure are equalized. This will happen at the constant volume and later remaining volume will be discharged and then it becomes zero. The compressor with such a fixed BIVR and over compression will follow trajectory “1-3′-2-3-3a”.

An ideal isentropic compressor will compress from 1-3′ and later discharge at constant pressure from 3′-3-3a to reduce the volume to zero.

If we compare a fixed BIVR compressor and an ideal isentropic compressor, the fixed BIVR compressor will have to do additional work of 3′-2-3-3′ for system pressure ratio requirement of 2. This is an over compression loss, and it occurs if the scroll BIVR is higher than the system pressure ratio requirement.

In the case of under compression (e.g., FIG. 8), assume operating the compressor at 53.5° F./145° F. condition. The related system pressures values are 187 PSIA and 1122 PSIA. Compressor system pressure ratios is (1122/187) which equal to 6.

With our predetermined scroll sets, our fixed BIVR scroll will generate 4.1 pressure compression. This ratio is less by 1.9. System pressure ratio is significantly high, and pressure rise in compressor is very low. Whenever the discharge port opens high pressure gas will flow to scrolls until scroll internal and system pressures are equal. In this example, a fixed BIVR compressor will follow the trajectory of 1-2-3-3′-3a. The process from 2-3 signifies the recompression of the discharge gas until scrolls hit the system pressure ratio of 6. This process (2-3) happens at constant volume and later the complete suction volume will be discharged at a pressure ratio of 6 from 3-3′-3a. The ideal isentropic compressor will follow the trajectory of 1-2-3′-3a to release the complete suction volume. The fixed BIVR compressor must do the extra work of 2-3-3′-2 for achieving the system pressure ratio demand of 6 compared to ideal compression. This is an under compression loss, and it occurs if scroll BIVR is lower than system pressure ratio demand.

In such under-compression cases, scroll sets and overall compressor will demand higher input horsepower rating from motor to do this additional work. Hence, in lower BIVR scroll sets, motor horsepower (HP) demand increases and overall torque rating also increases.

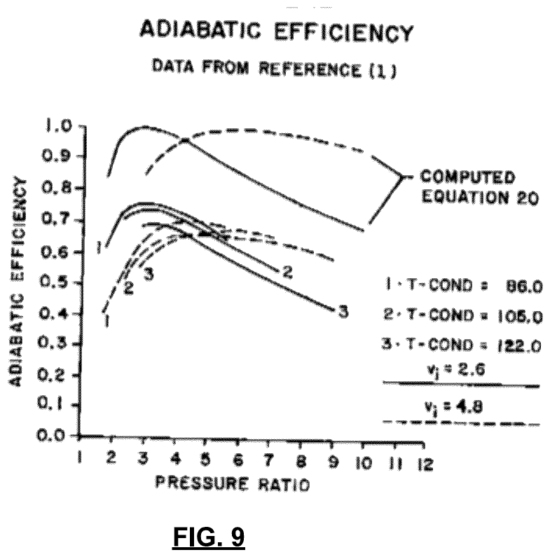

Next, adiabatic efficiency for different pressure ratios and BIVR will be discussed. FIG. 9 includes an example graph of values in this regard.

FIG. 9 illustrates the adiabatic efficiency of a compressor for different system pressure ratio demands. The graph is for BIVR of 2.6 and 4.8 varied for different condenser temperatures. From FIG. 9, it can be concluded that compressor adiabatic efficiency has only one peak efficiency value for range of system pressure ratio demands. It can also be concluded that a lower system compression ratio is equally severe as higher system compression ratio as efficiency reduces drastically. Hence, achieving better scroll efficiency at two stage part load condition can be important as scrolls may be in highly over compression.

Compressor adiabatic efficiency increases if system pressure ratio demand increases from a lowest possible pressure ratio until it reaches scroll built-in pressure ratio (BIPR). The range from lowest pressure ratio to the scroll BIPR can be considered an over compression range.

The peak of compressor adiabatic efficiency may occur when system pressure ratio demands becomes equal to scroll BIPR demand. This may be a best optimal pressure ratio for a compressor with highest efficiency.

Compressor adiabatic efficiency decreases if system pressure ratio demand increases above scroll BIPR. The range above the scroll BIPR may be an under compression range.

When designing a single phase induction motor for a fixed BIVR scroll compressor, to achieve a higher efficiency from the compressor, scrolls (BIVR or BIPR) and the electric motor powering to the scrolls are to be designed for a system pressure ratio which may frequently be used by the system for optimum cooling.

The electric motor may have a high or optimal efficiency at the scroll optimum BIVR. The range below the scroll BIPR will be underload for the motor and it may provide lower efficiency at these load points.

The electric motor has capacity to generate better efficiencies for certain HP ranges, but it may not give the same best efficiency for all the HP requirements from scroll sets. Also, an electric motor attached to a lower BIVR scroll set may need very high HP range for under compression of scroll sets. This factor may increase the electric motor cost and may compromise the efficiencies at optimum scroll BIPR.

These challenges will need a special solution for achieving better scroll efficiencies.

The present application involves using a multiple performance single phase motor for scroll design optimization. The tapped winding single phase induction motor gives controllability over range of motor efficiency and maximum HP.

The compressor scrolls for optimal BIVR or BIPR without considering the constraints from under compression scenario (High system compression ratios). Motor efficiency may be optimized at the scrolls optimum BIVR. When under compression occurs, few turns from motor winding can be removed and will make the motor HP increase. This will handle the under compression situation by supplying additional HP when required.

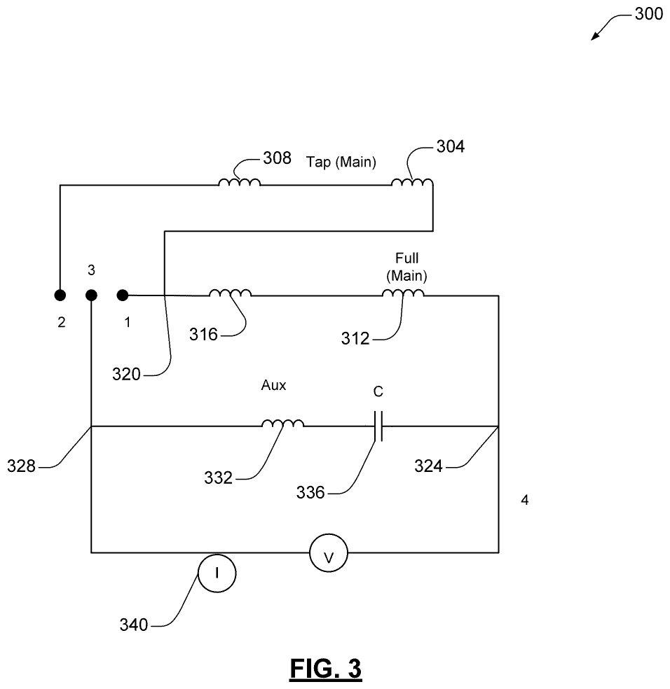

The compressor 102 is a scroll compressor and includes an electric motor that drives the scrolls. FIG. 3 is a schematic of an example implementation of the electric motor 300 of the compressor 102. The electric motor 300 includes a main winding including tapped winding portions 304 and 308 and winding portions 312 and 316. The tapped winding portions 304 and 308 form one winding section (e.g., ½) of the main winding, and the winding portions 312 and 316 form one winding section (e.g., ½) of the main winding. The electric motor 300 is a single phase induction motor. The main winding may be center tapped, forming the two winding sections.

The electric motor 300 includes four taps, labeled 1, 2, 3, and 4. The electric motor 300 is electrically connected to via the taps 1-4. The tap 4 may be electrically connected to a ground potential. The tap 1 is connected to a node 320.

The winding portions 312 and 316 are connected in series and at one end to the node 320. The other end of the winding portions 312 and 316 is connected to a node 324. In other words the winding portions 312 and 316 are connected between the nodes 320 and 324. The node 324 is electrically connected to the tap 4. The tapped winding portions 304 and 308 are electrically connected in series. The tapped winding portions 304 and 308 are electrically connected to the node 320 at one end and to the tap 2 at the other end. In other words, the tapped winding portions 304 and 308 are electrically connected between the node 320 and the tap 2.

A node 328 is electrically connected to the tap 3. The electric motor 300 also includes an auxiliary winding 332 and a capacitor 336 (run capacitor). The auxiliary winding 332 and the capacitor 336 are electrically connected in series and between the nodes 324 and 328.

A single phase voltage source V 340 provides power to the motor. The voltage source 340 may be, for example, an output of the drive 132.

A switch module (e.g., a cluster block) includes one or more switches and controls whether and how electrical power is applied to the taps. The switches may be, for example, contacts, relays, transistors, or another suitable type of switch. Line current may be measured by a line current sensor 340. A switch control module may control actuation of the switch(es).

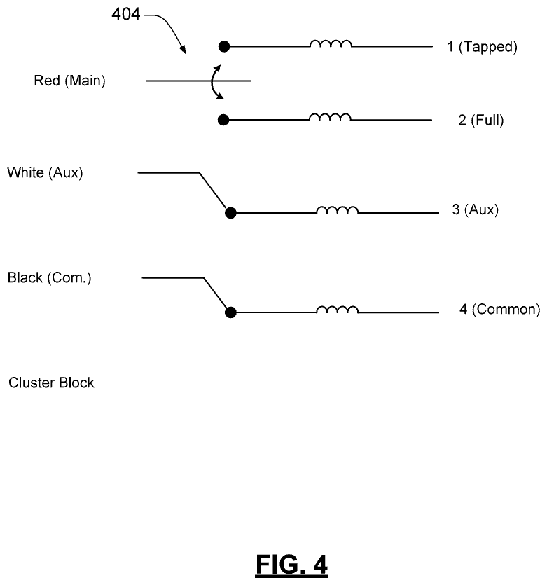

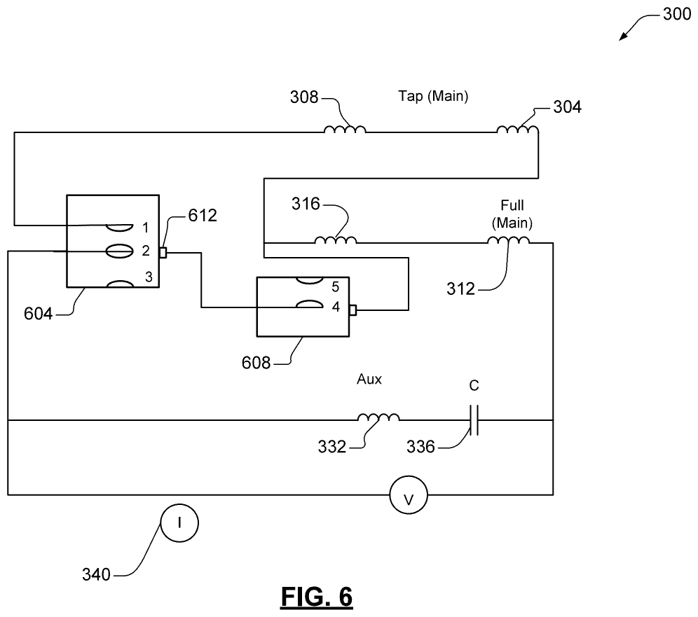

FIG. 4 is a functional block diagram of an example implementation of electrical connections. The red positive voltage potential carrying wire (red, hot) is connected to a switch 404. The switch 404 electrically connects the red wire to either the tap 1 or the tap 2 at a given time. The white (neutral) wire may be connected to the tap 3. A switch 412 electrically connects or disconnects the black positive voltage potential carrying wire (hot) is to or from the tap 4. A switch control module 450 (e.g., of the system controller 130) may control actuation of the switches 404-412. In various implementations (e.g., FIGS. 6, 10, 11), automatic switching (e.g., thermal/mechanical) may be performed within the compressor. In the example of automatic switching, the switch control module 450 may be omitted. In the example of FIGS. 6, 10, and 11, switches automatically actuate by measuring/sensing current and temperature as discussed below within the compressor.

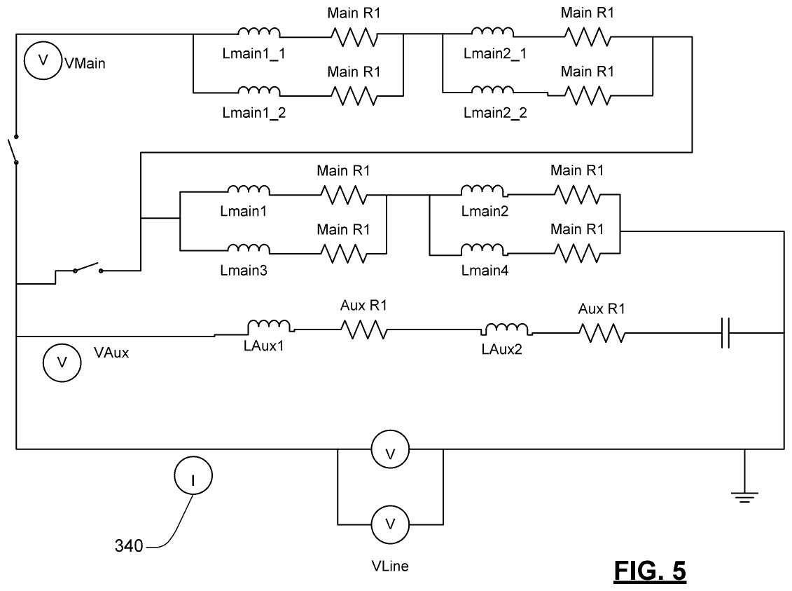

FIG. 5 is an example schematic of a model of the electric motor 300. Resistances of windings are illustrated by resistors. As illustrated, the switches are arranged such that the main winding can include both winding portions and can at some times be connected in series. At other times, the windings Lmain1_1-Lmain2_2 can be disconnected and only one of the winding portions (including the tapped windings Lmain1-4) can be connected.

While actuation of switches is discussed below as being performed by the switch control module 450, alternatively actuation may be performed automatically by the switches based on the measured current and/or temperature.

FIG. 6 is a schematic of an example implementation of the electric motor 300. Switches 604 and 608 are included. The switch control module 450 may control actuation of the switches 604 and 608. For example, when the line current is between 0 and a first predetermined current, the switch control module 450 may actuate the switch 604 such that the first and second contacts (1 and 2) are closed and electrically connected and the second and third contacts (2 and 3) are open and electrically disconnected from each other. The first predetermined current may be, for example, approximately 15 amps or another suitable current. The switch control module 450 actuates the switch 608 so the fourth and fifth contacts (4 and 5) are open and electrically disconnected from each other. The switch control module 450 may actuate the switches 604 and 608 in this way for undercompression operation. In this situation, the winding portions 304-316 are connected in series.

When the line current is between the first predetermined current and a second predetermined current, the switch control module 450 may actuate the switch 604 such that the first and second contacts (1 and 2) are open and electrically disconnected and the second and third contacts (2 and 3) are closed and electrically connected. The second predetermined current is greater than the first predetermined current and may be, for example, approximately 25 amps or another suitable current. The third contact is electrically connected to the output 612, which is electrically connected to the input of the switch 608. The switch control module 450 actuates the switch 608 so the fourth and fifth contacts (4 and 5) are closed and electrically connected. The switch control module 450 may actuate the switches 604 and 608 in this way for overcompression operation. In this situation, the winding portions 304-308 are not used while the winding portions 312-316 are electrically connected. In both situations, the auxiliary winding 332 is also used.

When the line current is greater than the second predetermined current, the switch control module 450 may actuate the switches 604 and 608 and shut off the electric motor 300. The switch control module 450 may actuate the switch 604 to electrically disconnect the second contact (2) from both the first and third contacts (1 and 3) and actuate the switch 608 to electrically disconnect the fourth and fifth contacts (4 and 5).

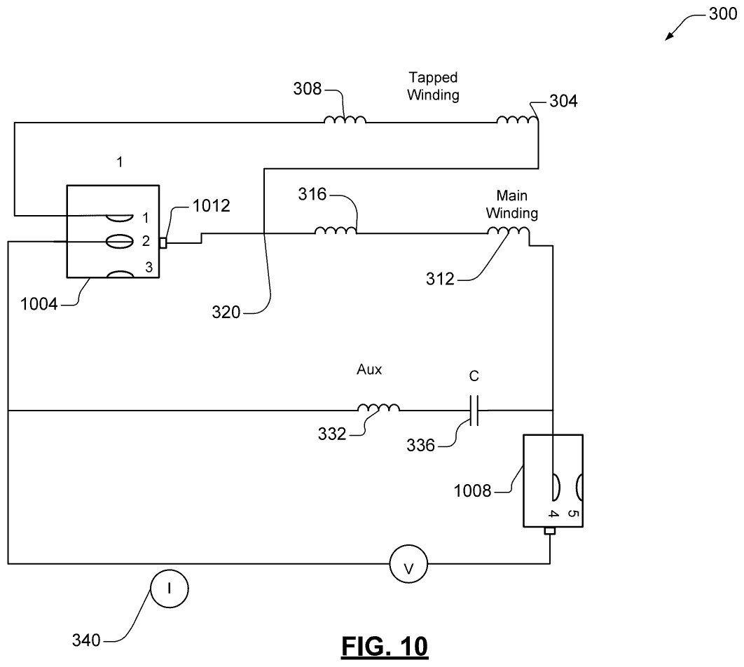

FIG. 10 is a schematic of an example implementation of the electric motor 300. Switches 1004 and 1008 are included. The switch control module 450 may control actuation of the switches 1004 and 1008. In various implementations, the switch control module 450 may be implemented within the compressor 102. In various implementations, the switch control module 450 may be omitted and automatic switching may be performed.

For example, when the line current is between 0 and the first predetermined current, the switch control module 450 may actuate the switch 1004 such that the first and second contacts (1 and 2) are closed and electrically connected and the second and third contacts (2 and 3) are open and electrically disconnected from each other. The switch control module 450 actuates the switch 1008 so the fourth and fifth contacts (f and 5) are closed and electrically connected. The switch control module 450 may actuate the switches 1004 and 1008 in this way for undercompression operation. In this situation, the winding portions 304-316 are connected in series.

When the line current is between the first predetermined current and the second predetermined current, the switch control module 450 may actuate the switch 1004 such that the first and second contacts (1 and 2) are open and electrically disconnected and the second and third contacts (2 and 3) are closed and electrically connected. The third contact is electrically connected to the output 1012, which is electrically connected to the node 320. The switch control module 450 actuates the switch 608 so the fourth and fifth contacts (4 and 5) are closed and electrically connected. The switch control module 450 may actuate the switches 604 and 608 in this way for overcompression operation. In this situation, the winding portions 304-308 are not used while the winding portions 312-316 are electrically connected. In both situations, the auxiliary winding 332 is also used.

When the line current is greater than the second predetermined current, the switch control module 450 may actuate the switches 1004 and 1008 and shut off the electric motor 300. The switch control module 450 may actuate the switch 1004 to electrically disconnect the second contact (2) from both the first and third contacts (1 and 3) and actuate the switch 1008 to electrically disconnect the fourth and fifth contacts (4 and 5)

In the example of FIG. 10, the switch 1008 is placed differently and in series with common and supply terminals. This layout may be useful, for example, to trip the motor connection during the event of overcurrent or fault condition.

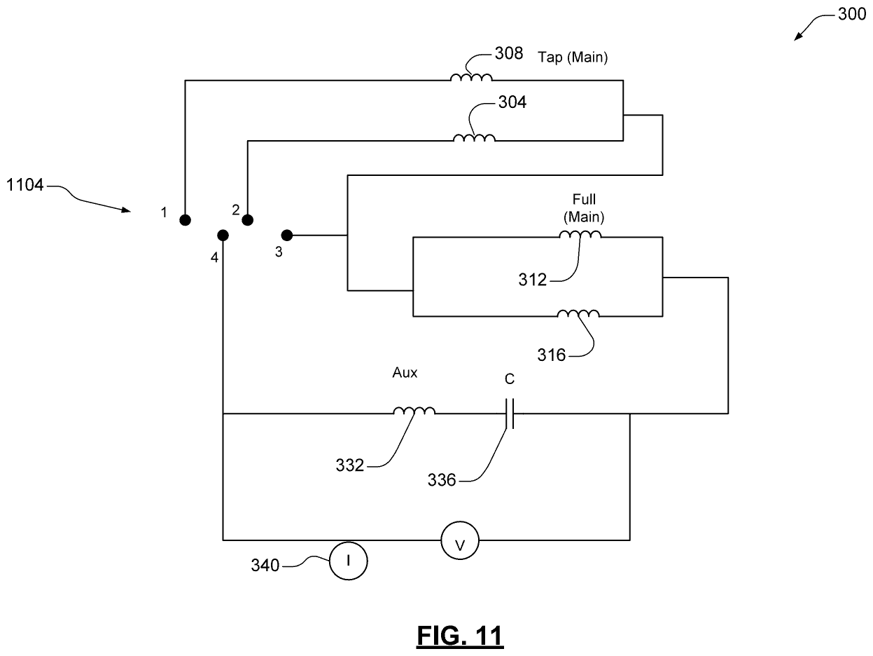

FIG. 11 includes a schematic of an example implementation of the electric motor 300. Switch 1104 is included. The switch control module 450 may control actuation of the switch 1104. In various implementations, the switch control module 450 may be implemented within the compressor 102. In various implementations, the switch control module 450 may be omitted and automatic switching may be performed as described above. In the example of FIG. 11, the winding portions are electrically connected in parallel to create a multiple performance single phase induction motor.

In this example, leads 1, 2 & 4 are electrically connected via the switch 1104 for full winding operation. Also, leads 4 and 3 can be electrically connected for tapped winding operation. The configuration of FIG. 11 can achieve multiple performance with a single phase induction motor even if windings are connected in parallel.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A single phase induction motor of a scroll compressor, the motor comprising:
a main winding that is center tapped forming:
a first winding having a first end and a second end;
a second winding having a third end and a fourth end; and
a node between the second end of the first winding and the third end of the second winding;
a first switch:
including a first input to receive single phase power from a source;
including a first output connected to the first end of the first winding; and
including a second output;
a second switch:
including a second input connected to the second output of the first switch;
including a third output connected to the node between the second end of the first winding and the third end of the second winding; and
an auxiliary winding.

2. The motor of claim 1 further comprising a capacitor connected in series with the auxiliary winding.

3. The motor of claim 2 wherein the auxiliary winding and the capacitor are connected between the first input of the first switch and the fourth end of the second winding.

4. A motor control system, comprising:
the motor of claim 1; and
a switch control module configured to actuate the first and second switches.

5. The motor control system of claim 4 wherein the switch control module is configured to actuate the first and second switches based on a line current from the source.

6. The motor control system of claim 5 wherein the switch control module is configured to, when the line current is between zero and a first predetermined current:
actuate the first switch and electrically connect the first input to the first output and electrically disconnect the first input from the second output.

7. The motor control system of claim 6 wherein the switch control module is further configured to, when the line current is between 0 and the first predetermined current, actuate the second switch and electrically disconnect the second input from the third output.

8. The motor control system of claim 5 wherein the switch control module is further configured to, when the line current is between the first predetermined current and a second predetermined current that is greater than the first predetermined current:
actuate the first switch and electrically disconnect the first input from the first output and electrically connect the first input to the second output; and
actuate the second switch and electrically connect the second input to the third output connected to the node between the second end of the first winding and the third end of the second winding.

9. The motor control system of claim 8 wherein the switch control module is further configured to, when the line current is greater than the second predetermined current:
actuate the first switch and electrically disconnect the first input from both the first output and the second output; and
actuate the second switch and electrically disconnect the second input from the third output connected to the node between the second end of the first winding and the third end of the second winding.

10. The motor control system of claim 4 wherein the switch control module is configured to, based on undercompression operation of the compressor:
actuate the first switch and electrically connect the first input to the first output and electrically disconnect the first input from the second output.

11. The motor control system of claim 10 wherein the switch control module is further configured to, based on overcompression operation of the compressor:
actuate the first switch and electrically disconnect the first input from the first output and electrically connect the first input to the second output; and
actuate the second switch and electrically connect the second input to the third output connected to the node between the second end of the first winding and the third end of the second winding.

12. The motor control system of claim 1 wherein at least one of the first and second switches automatically actuates based on a line current from the source.

13. A single phase induction motor of a scroll compressor, the motor comprising:
a main winding that is center tapped forming:
a first winding having a first end and a second end;
a second winding having a third end and a fourth end; and
a first node between the second end of the first winding and the third end of the second winding;
a first switch:
including a first input to receive single phase power from a source via a second node;
including a first output connected to the first end of the first winding; and
including a second output connected to the first node between the second end of the first winding and the third end of the second winding;
a second switch:
including a second input connected to the fourth end of the second winding via a third node;
including a second output connected to the source; and
an auxiliary winding connected between the third node and the second node.

14. The motor of claim 13 further comprising a capacitor connected in series with the auxiliary winding.

15. A motor control system, comprising:
the motor of claim 13; and
a switch control module configured to actuate the first and second switches.

16. The motor control system of claim 15 wherein the switch control module is configured to actuate the first and second switches based on a line current from the source.

17. The motor control system of claim 16 wherein the switch control module is configured to, when the line current is between zero and a first predetermined current:
actuate the first switch and electrically connect the first input to the first output and electrically disconnect the first input from the second output.

18. The motor control system of claim 17 wherein the switch control module is further configured to, when the line current is between zero and the first predetermined current, actuate the second switch and electrically disconnect the second input from the third output.

19. The motor control system of claim 16 wherein the switch control module is further configured to, when the line current is between the first predetermined current and a second predetermined current that is greater than the first predetermined current:
actuate the first switch and electrically disconnect the first input from the first output and electrically connect the first input to the second output; and
actuate the second switch and electrically connect the second input to the third output.

20. The motor control system of claim 19 wherein the switch control module is further configured to, when the line current is greater than the second predetermined current:
actuate the first switch and electrically disconnect the first input from both the first output and the second output; and
actuate the second switch and electrically disconnect the second input from the third output.

21. The motor control system of claim 15 wherein the switch control module is configured to:
based on undercompression operation of the compressor, actuate the first switch and electrically connect the first input to the first output and electrically disconnect the first input from the second output; and
based on overcompression operation of the compressor:
actuate the first switch and electrically disconnect the first input from the first output and electrically connect the first input to the second output; and
actuate the second switch and electrically connect the second input to the third output.
